(19) United States
(12) Patent Application Publication
(10) Pub. No.: US 2022/0358567 A1
(43) Pub. Date: Nov. 10, 2022

(54) HIERARCHY-BASED SELECTION

(71) Applicant: Horacio Duhart, Plano, TX (US)

(72) Inventor: Horacio Duhart, Plano, TX (US)

(21) Appl. No.: 17/738,000

(22) Filed: May 5, 2022

Related U.S. Application Data
(60) Provisional application No. 63/184,203, filed on May 5, 2021.

(51) Int. Cl. G06Q 30/06

(52) U.S. Cl. CPC G06Q 30/0641; G06Q 30/0633; G06Q 30/0629

(57) ABSTRACT

The present invention provides a hierarchy-based search system and method primarily used to shop for goods or services. The system includes either multiple rows or multiple columns arranged as user-selectable tiles (including buttons) that together incorporate hierarchies of product abstraction which include, from a broadest meta (large) product categories, to one or more granular (specific) product categories. Then, as a user searches for a product or service, that search and the results of the search are augmented by user-selectable tiles that further limit/filter the displayed search results such that only results consistent with the category selection are displayed to the user. Accordingly, a natural sequence of purchasing choice selection decisions are presented to the user so that they can more naturally narrow shopping choices and make faster, better purchasing decisions.

### CLAIM OF PRIORITY, IDENTIFICATION OF RELATED APPLICATIONS

This Non-Provisional patent application claims priority from U.S. Provisional Patent Application No. 63/184,203 filed on 5 May 2021 entitled Hierarchy-Based Selection, to common inventor Horacio Duhart.

### TECHNICAL FIELD

The present invention generally relates to data processing and presentation techniques for e-commerce, and more specifically relates to interactive online shopping tools and interactive online shopping methods.

### PROBLEM STATEMENT AND HISTORY

### Interpretation Considerations

This section describes technical field in detail and discusses problems encountered in the technical field. Therefore, statements in the section are not to be construed as prior art.

### Discussion of History of the Problem

In addition to convenience, speed and competitive pricing, we can now add global pandemics to the list of reasons why consumers are choosing to make more of their purchases online. Yet in 2020—despite the pandemic—less than 20% of consumer purchases in the United States and other places were made online. Accordingly, online sales are trending to continue to become more common and have plenty of room to grow.

When internet shopping was beginning in the early 2000s, platforms such as eBay® presented customers with a confusing variety of shopping options. Fast forward to today and platform-based online shopping “stores” on eBay® and Amazon® provide sellers the ability to reach their customers in ways that add value (and price) to a transaction.

However, when consumers shop online, they are faced with difficult to navigate interfaces that make product (including service) categories difficult to navigate and filter. Specifically check-boxes and drop-down selection tools confuse consumers and often consume 25% or more of a website or App's visual footprint (also called ‘visual real estate’ and/or ‘visible screen display area’).

Accordingly, what is needed is an online shopping tool provides consumers a better shopping experience, and guides the consumer to visually see the few selections on the screen that match what he/she is really looking for while consuming a smaller visual footprint. The present invention provides such a solution.

### Topically Related Publications

Software technology for online shopping systems is a busy field dense with new technologies and patent application filings, such as:

WO2016000044, titled as online shopping system and method of purchase of products by customers, the method comprising: in respect of a plurality of items available from each of a plurality of retailers, obtaining the price of each item for purchase from each retailer; receiving an indicator of a region from a customer (region indicator); receiving a list of items for purchase from the customer; determining the cost of each of the items in the received list for each of the retailers based on the received region indicator; and determining a shopping list for each retailer based on the determined costs. But the application does not disclose about brands and prior art system does not provide filtering by brand, moreover, the prior art is not related to solar power industry products.

US20140351090 titled as graphical user interface for presentation of items and is related to methods and apparatuses for presenting a user interface for visual search results are described herein. The methods include indexing a plurality of metadata values of each of a plurality of items and generating a plurality of item categories based on the plurality of metadata values, and determining a primary item category and a subordinate item category from the plurality of categories. But the patent application does not claim features of the present invention with respect to brand selection.

U.S. Pat. No. 7,996,282 titled as method and system for selecting and displaying items related to methods and systems for causing the display of items for the review and selection thereof by a potential purchaser has a plurality of search tools whereby a customer can select certain search criteria for displaying items corresponding to the search criteria for review and selection thereof and comparison there between. The prior art application fails to disclose brand row search.

### SUMMARY

The invention provides a method of exploring and selecting retail products (including herein services) via a selectively stacked sequence of displayed consumer choices (or “offerings”), including meta (large) product categories, granular (specific) product categories, and product type categories. The display of results changes dynamically based on, at least in part, the user's section(s), preferably without requiring an additional “selection” step (such as a search), where the user must press a ‘return’ key, “click” a search button, or otherwise indicate that a search is to be made and/or that the display is to be updated.

One embodiment associated with user-selection hierarchies of product abstraction which include, from broadest to most narrow: meta (large) product categories, granular (specific) product categories, and product types category, product sub-type category 1, product sub-type category 2, etc. What defines a meta product category depends on the context of the search, and on the website in particular.

For example, when shopping on a site such as Amazon with millions of available products, a meta product category may include categories such as “linens” or “automotive” or “hardware” or “clothing” or other common large retail categories. By contrast, if shopping a website that sells a residential alternative energy product, a meta product category may include categories such as “wind power” or “power storage” or “solar power” and the like. Similarly, if shopping a website that sells residential solar power, then a meta-category may include “solar panels” or “batteries” or “installation tools” or “maintenance.” Accordingly, the more specific the shopping website, the more granular the meta category. The consequence of this is that the definition of what defines a category, from meta category down to a sub-type category 2 while hierarchically consistent within a specific embodiment, are relative across embodiments and their careful selection on the part of the software architect and user-experience specialist assists consumers in having a good shopping experience.

In one embodiment, the method displays product choices related to products, presented as:
1. A first row or column displaying a series of tiles or buttons (“first row tiles”, where each first-row tile comprises an image and/or a word, where each tile is of a generalized product meta-category.
2. A second row or column displaying a series of tiles or buttons (“second row tiles”), where each second-row tile comprises an image and/or a word, where each tile further narrows one or more of the meta categories. If the user has selected a meta category, then the second-row tiles that are displayed relate only to the previously selected first row tile, and are defined as a granular product category.
3. A third row/column displaying a series of tiles or buttons (“third row tiles”), where each third-row tile comprises an image and/or a word, where each tile further narrows one or more of the granular product category into a sub-type category 1, such as a brand name. Of course, depending on the context of display, a brand may be any of a meta category down to a sub-type category. If the user has selected a second-row tile, then the brands displayed relate only to the previously selected second-row tile. For example, if a user has selected a second-row tile of “solar panels” then the third-row tiles all display brands of solar panels, such as SHARP®, JA Solar®, or Jinko Solar®.
4. A fourth row/column displaying a series of tiles or buttons (“third row tiles”), where each fourth-row tile comprises an image and/or a word, where each fourth-row tile further narrows one or more of the granular product category(ies) into a sub-type 2 category, such as a solar panel type of the brand name selected. Of course, depending on the context of display, a brand may be any of a meta category down to a sub-type category. If the user has selected a the second-row tile, then the brands displayed relate only to the previously selected second-row tile. For example, if a user has selected a second-row tile of “solar panels” and SHARP as the only brand from the third tile row, than then the fourth-row tiles all display types of solar panels available from SHARP, such as poly, mono, bifacial, and the like.
5. As a user makes each tile selection, the products shown to the user reflect the products available at the selected level of abstraction.

Accordingly, initially, when no selections have been made, a bottom portion of a sales page may display promoted items or items presented/sorted based on retailer or user preferences.

Then, as a user selects a meta category (first-row tile), the items displayed at the bottom of the page change dynamically to reflect the smaller set of items that now meet that choice criteria. Further, the choices available to a user in the second tile row are now limited to choices that are consistent with that selection. Similarly, if a user selects a more narrow category, such as a granular category, before selecting a meta category, the method automatically incorporates the relevant meta-categories as being also selected and automatically displays these now-active meta category(ies) to the user as if it/they were selected. Likewise, as the user selects each more narrow sub-category, the items displayed at the bottom of the page change dynamically to reflect the smaller set/sub-set(s) of items that now meet that choice criteria.

Of course, the present is simply a Summary, and not a complete description of the invention.

### BRIEF DESCRIPTION OF THE DRAWINGS

Various aspects of the invention and its embodiment are better understood by referring to the following detailed description. To understand the invention, the detailed description should be read in conjunction with the drawings, in which:

FIG. 1 illustrates overview of an online retail product/service search system.

FIG. 2 is a flow chart illustrating an interactive online shopping algorithm (aka “online hierarchical search algorithm”).

FIG. 3 illustrates a flow chart describing an online hierarchical search algorithm with respect to display and comparative product analysis for products belonging to same brand in connection with FIG. 2.

FIG. 4 illustrates procedural acts of a cart selection algorithm on a retail database in connection with FIG. 2.

FIG. 5 illustrates an example handheld electronic device presenting data items using the online hierarchical search algorithm.

FIG. 6 is an example screenshot of the online hierarchical search for a first brand type inverter.

FIG. 7 is an example screenshot of the online hierarchical search for a second brand type inverter.

FIG. 8 is an example screenshot of the online hierarchical search for a third brand type inverter.

FIG. 9 is an example screenshot of the online hierarchical search for a solar panel.

FIG. 10 is an example screenshot of the online hierarchical search for installation supplies.

FIG. 11 is an example screenshot of the online hierarchical search for mounting systems.

FIG. 12 is an example screenshot of the online hierarchical search for monitoring and optimizers.

FIG. 13 is an example screenshot of the online hierarchical search for first brand type batteries and controllers.

FIG. 14 is an example screenshot of the online hierarchical search for second brand type batteries and controllers.

FIG. 15 is an example screenshot of the online hierarchical search for a microinverter.

FIG. 16 is an example screenshot of an in-vehicle display depicting the online hierarchical search for a song selection service.

FIG. 17 is an example screenshot of the in-vehicle display depicting the online hierarchical search for a frequency modulation (FM) selection service.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### Description of the Drawings, a Preferred Embodiment

The present invention generally relates to online and touch screen shopping software and has application across a variety of different retail and wholesale shopping environments, such as electric cars, smart televisions, smart phones applications, and clothing, for example. More broadly, the invention is a hierarchical search tool that has application across structured data generally.

In one embodiment of the present invention, what is provided are a row or column (or both) of naturally sequenced tiles that assist users with making a selection during a purchasing process.

The present invention provides an effective platform for a user to select brands, where the user using an electronic device is empowered to make selections for a product category and then narrow down that selection so that the use is not overwhelmed with choices of displayed products ‘matching’ a nominal search—especially the reduction or elimination of the display of products irrelevant to the user.

Selection in this sense is independent of the hardware platform in use. And exemplary hardware platforms include hand-held devices, such as smart phones, pad-type computers, laptops, kiosk, smart televisions, desktops, or car display monitor, for example. Selections may be indicated verbally, by touch via a touch-screen display, with gestures including hand and eye gestures, for example.

In other words, the present invention provides a shopping tool that can be used online that provides consumers a better shopping experience by guiding the consumer to make additional purchases—ideally from that same seller.

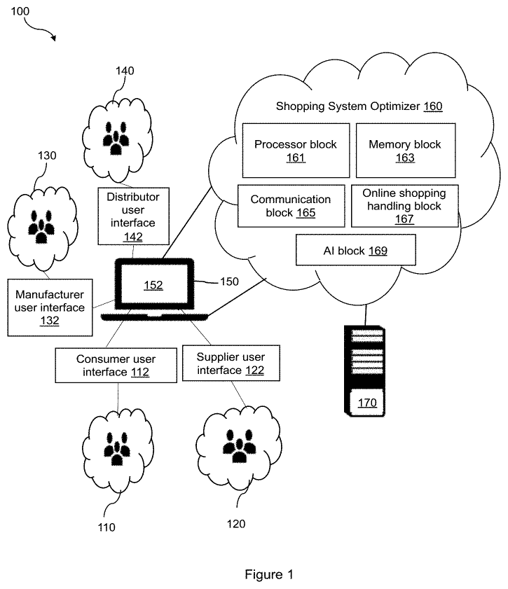

FIG. 1 illustrates an overview of an online retail product/service search system (the “online retail search system”) 100. The online retail search system 100 includes one or more users 110, 120, 130 and 140, an electronic device 150, a shopping system optimizer 160 and a server 170.

The one or more users may be consumers 110, suppliers 120, manufacturers 130, and distributors 140, for example. The one or more users 110, 120, 130 and 140 can access the shopping system optimizer 160 through their respective user interfaces, like a consumer user interface 112, a supplier user interface 122, a manufacturer user interface 132, and a distributor user interface 142, for example.

The electronic device 150 can be a laptop, a notebook, a desktop computer, a vehicle to everything (V2X) device, a smartphone, a tablet, an internet of things (IoT) device, a television with communication facility, an immersive device, a virtual reality device, a pager or any other computing device including similar hardened and field-specific devices, for example. Alternatively, the present invention is implemented in any type of standard or touch color screen including devices such as a smart television screen, Electric Car touch screen, convenient store or mall information kiosk touch screen. The electronic device 150 includes a display 152. The display 152 can be a liquid crystal display (LCD), a light emitting diode (LED) display, for example.

The shopping system optimizer 160 includes a processor block 161, a memory block 163, a communication block 165, an online shopping handling block 167, and an Artificial Intelligence (AI) block 169. In an embodiment, the shopping system optimizer 160 is running in the electronic device 150. In another embodiment, the shopping system optimizer 160 is running in the server 170. The server 170 can be, for example, but not limited, to an edge server, a cloud server.

The processor block 161 is coupled with the memory block 163, the communication block 165, the online shopping handling block 167, and the AI block 169. The processor block 161 can have one or more processors, which may be configured to perform all the processing functionalities of the present invention. The one or more processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU), for example. The memory block 163 includes a non-volatile memory, a volatile memory, for example and stores the information/data relevant to the present invention. The communication block 165 communicates with internal blocks of the electronic device 150, the shopping system optimizer 160 and the server 170.

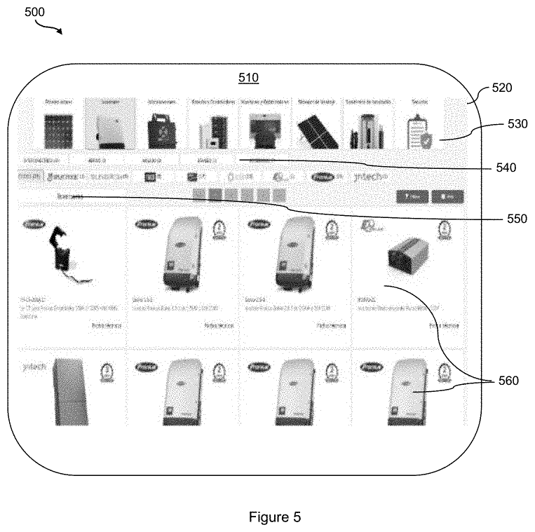

The online shopping handling block 167 receives at least one input to determine and display at least one first data item from a plurality of first data items on the display 152 of the electronic device 150 in a direction (“customized direction”). The direction can be, for example, but not limited to, a horizontal direction, a vertical direction, a diagonal direction, a top-to-bottom direction, and a bottom-to-top direction. The input can be, for example, but not limited to a voice input, a touch input, a gesture input or the like. The at least one data item comprises a product and a service. Based on the input, the online shopping handling block 167 selects the at least one first data item from the plurality of first data items to navigate to at least one second data item from a plurality of second data items on the display 152 of the electronic device 150 based on the selection. The at least one second data item corresponds to at least one sub-category of the at least one first data item. Further, the online shopping handling block 167 selects the at least one second data item from the plurality of second data items to navigate to at least one third data item from a plurality of third data items on the display 152 of the electronic device 150 based on the selection. The at least one third data item corresponds to at least one sub-category of the at least one second data item. The at least one first data item, the at least one second data item and the at least one third data item are arranged in sequential order (as shown in FIG. 5 to FIG. 17). The at least one sub-category is determined based on a context of the at least one input and a common feature of the at least one selected data item. Various example of the online retail search is explained in conjunction with FIG. 5 to FIG. 17.

Further, the online shopping handling block 167 learns a user behavior over a period of time and provides a suggestion to perform at least one action on the at least one selected data item. The suggestion can be, for example but not limited to, a location-based suggestion, a price based suggestion, an availability based suggestion, a quick deliverable related suggestion.

In an example, the online shopping handling block 167 initiates a purchase transaction for the at least one selected data item with the server 170 and receives a payment confirmation for the at least one selected data item from the server 170.

In yet another example, the online shopping handling block 167 allows the one or more users 110, 120, 130 and 140 of the electronic device 150 to add the at least one selected data item in a cart (aka “shopping cart”), where the online shopping handling block 167 initiates a purchase transaction for the at least one selected data item by communicating with the server 170 and receives the payment confirmation for the at least one selected data item from the server 170. The electronic device 150 shares the input to the server 170 and the server 170 fetches at least one data item based on the input received from the electronic device 150. The online shopping handling block 167 is configured to compare two or more selected data items and identify and purchase an optimal/relevant data item from the two or more selected data items based on the comparison.

In an embodiment, the AI block 169 implements a machine learning method called deep learning. The machine learning method enables the platform to automatically learn and improve from experience, over a period of time, without being explicitly programmed. The deep learning method uses a neural network capable of learning in an unsupervised manner from data that is unstructured or unlabeled. Deep learning is a method of machine learning that employs multiple layers of neural networks that enable the platform of the present invention to teach itself through inference and pattern recognition, rather than development of procedural code or explicitly coded software algorithms (however, machine learning is augmented and enhanced with software algorithms). The neural networks are modeled according to the neuronal structure of a mammal's cerebral cortex, where neurons are represented as nodes and synapses are represented as uniquely weighted paths or “tolled roads” between the nodes. The nodes are then organized into layers to comprise a network. Additionally, the neural networks are organized in a layered fashion that includes an input layer, intermediate or hidden layers, and an output layer.

The neural networks enhance their learning capability by varying the uniquely weighted paths based on received input. The successive layers within the neural network incorporate the learning capability by modifying their weighted coefficients based on their received input patterns. From this foundation, one can see that the training of the neural networks is very similar to how we teach children to recognize an object. The neural network is repetitively trained from a base data set, where results from the output layer (or, simply “output”) are successively compared to the correct classification.

Alternatively, any machine learning paradigm instead of neural networks can be used in the training and learning process.

A function associated with the AI block 169 may be performed by utilizing the information stored in the memory block 163 and by utilizing the information processed by the processor block 161.

Although FIG. 1 shows various components of the online retail search system 100 but it is to be understood that other embodiments are not limited thereon. The online retail search system 100 may include less or more number of components. Further, the labels or names of the components are used only for illustrative purpose and does not limit the scope of the present invention. One or more components can be combined together to perform same or substantially similar function in the online retail search system 100.

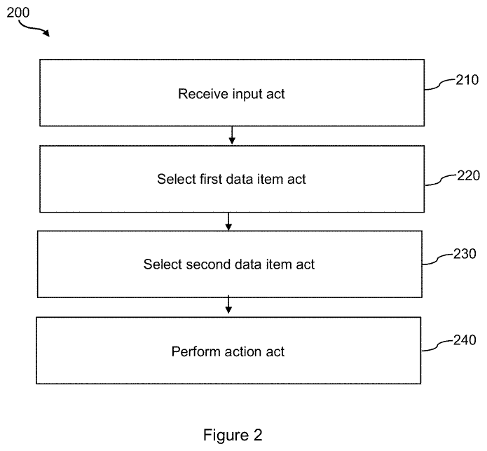

FIG. 2 is a flow chart illustrating an interactive online shopping algorithm (aka “online hierarchical search algorithm”) 200.

In a receive input act 210, the shopping system optimizer 160 receives the at least one input to determine and display the at least one first data item from the plurality of first data items on the display 152 of the electronic device 150 in the customized direction as described above. Next, in a select first data item act 220, the shopping system optimizer 160 selects the at least one first data item from the plurality of first data items to navigate to at least one second data item from the plurality of second data items on the display 152 of the electronic device 150 based on the selection. The at least one second data item corresponds to at least one sub-category of the at least one first data item. Next, in a select second data item act 230, the shopping system optimizer 160 selects the at least one second data item from the plurality of second data items to navigate to at least one third data item from the plurality of third data items on the display 152 of the electronic device 150 based on the selection. The at least one third data item corresponds to at least one sub-category of the at least one second data item. Finally, in a perform action act 240, the shopping system optimizer 160 performs the at least one action on the at least one selected data item. The at least one action can be, for example, but not limited to a purchase order, a payment action, an adding to the cart action or the like.

In the existing method, in an example, so, when people try to order a “solar panel system” for their home or business, they often buy parts that are completely incompatible with each other, and sometimes they neglect to purchase everything they need. This results in reducing the user experience. Advantageously, the proposed method assists a user/buyer walking them through the building process by showing them only purchase choices for items that are compatible with the parts they already have in their basket (or in their pre-basket). The proposed method allows a buyer to create several of the hypothetical builds so that they can create the bundle of products that best fits their priority of performance and budget.

Although, the online hierarchical search algorithm 200 is explained in view of the consumer 110, however, the online hierarchical search algorithm 200 is not limited to the consumers only and is also applicable to the other users as explained in FIG. 1.

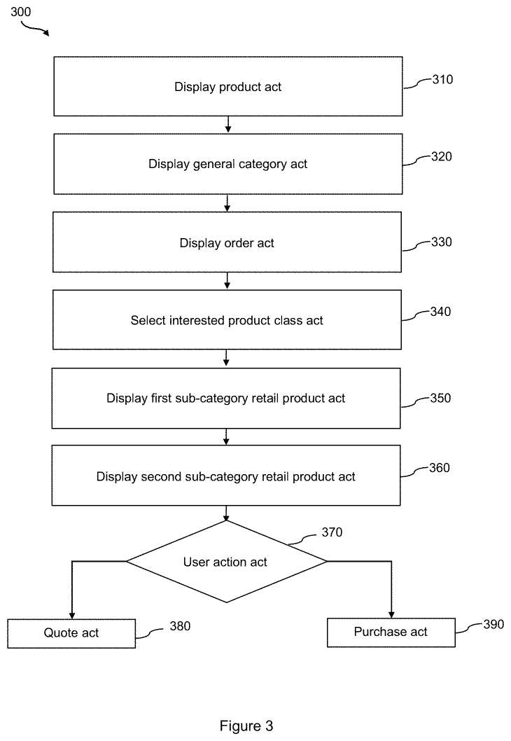

FIG. 3 illustrates a flow chart describing an online hierarchical search algorithm 300 with respect to display and comparative product analysis for products belonging to same brand in connection with FIG. 2.

In a display product act 310, the electronic device 150 displays images/text products/items/services from the memory block (aka “retail product database/memory block”) 163. The display of products is arranged in series of rows or columns and optionally. In various embodiments, the displayed information can be sequentially placed (in multiple windows) from left to right or from right to left, and from top to bottom or from bottom to top.

In a display general category act 320, the electronic device 150 displays the images/text details of products that belongs to a generalized category. In a display order act 330, the products displayed are pre-arranged based on a seller criteria. In a select interested product class act 340, the one or more users 110 (for example, consumer 110) of the electronic device 150 select a desired product class. In a display first sub-category retail product act 350, in response to the user selection, the electronic device 150 presents a new second row/column belonging to the class selected. Again, the user selection, in a display second sub-category retail product act 360 presents a new third row/column belonging to the class selected. In a user action act 370, the electronic device 150 presents a product/service selected by the user. With simultaneous reference to act 380 and act 390, the one or more users 110 of the electronic device 150 may save the selection as a Quote in a quote act 380 or directly to a cart for purchase in a purchase act 390.

Although, the online hierarchical search algorithm 300 is explained in view of the consumer 110, however, the online hierarchical search algorithm 300 is not limited to the consumer only and is also applicable to the other users as explained in FIG. 1.

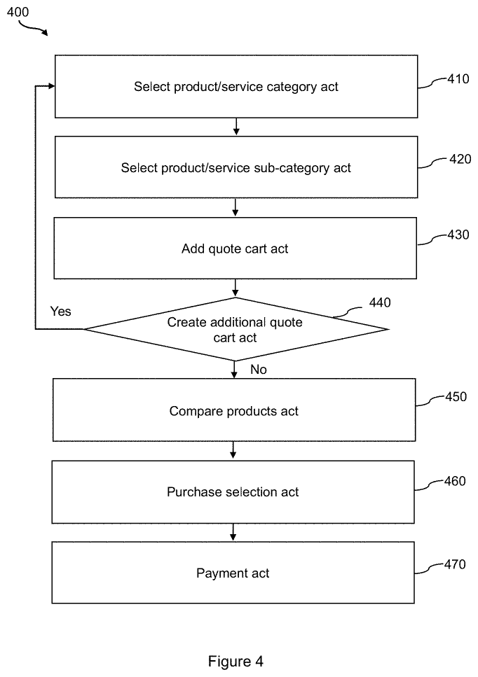

FIG. 4 illustrates a flow chart of a cart selection algorithm 400 on a retail database in connection with FIG. 2. The retail database may be located in the memory block 163, or in the online shopping handling block 167 or in the server 170.

In a select product/service category act 410, the one or more users 110 (for example “consumer”) of the electronic device 150 select an image/text corresponding to a category of product/service; for example, image/text related to solar energy sector. In a select product/service sub-category act 420, the one or more users 110 of the electronic device 150 select a sub-category of product (or item)/service. Next, in an add quote cart act 430, the one or more users 110 of the electronic device 150 select the product/service to add to a Quote cart. Next, in a create additional quote cart act 440, the one or more users 110 are provided with an option to create additional quote cart. If the one or more users 110 opt to create additional quote cart, the cart selection algorithm 400 proceeds to “Yes” path and the act 410 to act 430 are repeated until the one or more users 110 have filled the Quote cart with the items/services that are desired for purchase. Else, the cart selection algorithm 400 proceeds to “No” path.

Next, in compare products act 450, the electronic device 150 displays the quotes for comparison. Further, in a purchase selection act 460, the one or more users 110 of the electronic device 150 may assign points or weight to various criteria for making the purchase selection. Lastly, in a payment Act 470, a selected quote is converted into a shopping cart for checkout and payment.

Although, the cart selection algorithm 400 is explained in view of the consumer 110, however, the cart selection algorithm 400 is not limited to the consumer only and is also applicable to the other users as explained in FIG. 1.

FIG. 5 illustrates a handheld electronic device 500 having a hardware display screen 510 which, when on, presents a display 520 (window/web page) having display elements thereon, including images that represent brands, product types, solar components, power storage (such as batteries), installations tools, and the like.

More particularly, in FIG. 5 is seen selected functionality of the online shopping handling block 167 as employed in the online hierarchical search algorithm 200. The display 520 initially has an appearance that is similar to other consumer search tools. Here, a product category tool bar row 530 has elements shown as a series of images and words. Specifically, one element shows the words “Services” and has an image of a note pad with a check mark representing a completed task. Additionally, a row of product or service brands 540 is shown based on a user selection of an element in the product category toolbar row 530.

User feedback display tab 550 informs the user of the selection they made from the product category toolbar row 530 and/or the row of product or service brands 540. Common selection criteria that may be shown to the user via the user feedback display tab 550 include brands, category, types of sub-categories, kits, and new arrivals, for example.

Specific products available for purchase, which meet the user-selected element(s) (in other words, the criteria) chosen in row 530 and/or 540 are displayed in the lower half of the display 520 as two rows of elements 560, typically products or services, but here shown as inverters.

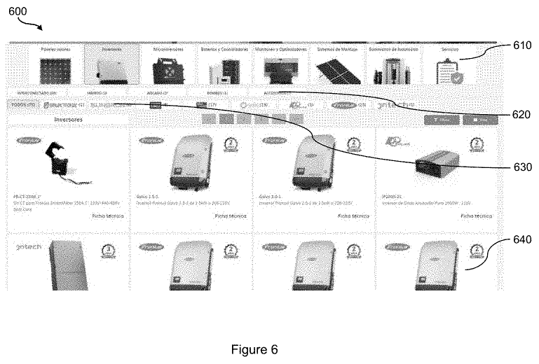

FIG. 6 is an example screenshot 600 of the online hierarchical search for a first brand type inverter, where the one or more users 110 of the electronic device 150 select one class from the presentation of classes (or types or categories) of items/services displayed as images or text in row 610 (although illustrated as a row 610 in FIG. 6, the presentation may take the form of a column as well). Further, the one or more users 110 select the sub-class (sub-type or sub-category) of product/service from the choices displayed as series of images or text 620. The one or more users 110 select a brand (i.e., first brand type inverter) from a series of brands 630 available based on the user selections and accordingly view a dynamically changing presentation of product choices 640 that are displayed as a function of the user's selection choices.

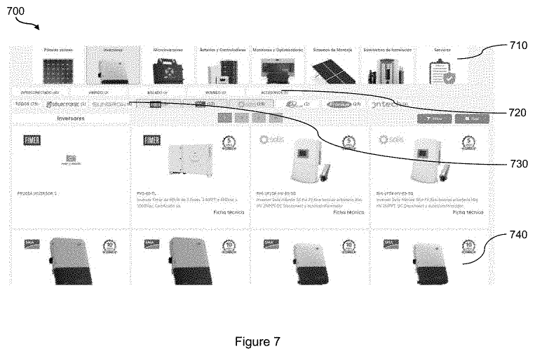

FIG. 7 is an example screenshot 700 of the online hierarchical search for a second brand type inverter, where the one or more users 110 of the electronic device 150 select one class from the presentation of classes (or types or categories) of items/services displayed as images or text in row 710 (although illustrated as a row 710 in FIG. 7, the presentation may take the form of a column as well). Further, the one or more users 110 select the sub-class (sub-type or sub-category) of product/service from the choices displayed as series of images or text 720. The one or more users 110 select a brand (i.e., second brand type inverter) from a series of brands 730 available based on the user selections and accordingly view a dynamically changing presentation of product choices 740 that are displayed as a function of the user's selection choices.

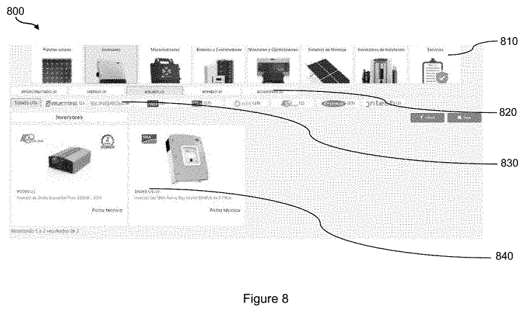

FIG. 8 is an example screenshot 800 of the online hierarchical search for a third brand type inverter, where the one or more users 110 of the electronic device 150 select one class from the presentation of classes (or types or categories) of items/services displayed as images or text in row 810 (although illustrated as a row 810 in FIG. 8, the presentation may take the form of a column as well). Further, the one or more users 110 select the sub-class (sub-type or sub-category) of product/service from the choices displayed as series of images or text 820. The one or more users 110 select a brand (i.e., third brand type inverter) from a series of brands 830 available based on the user selections and accordingly view a dynamically changing presentation of product choices 840 that are displayed as a function of the user's selection choices.

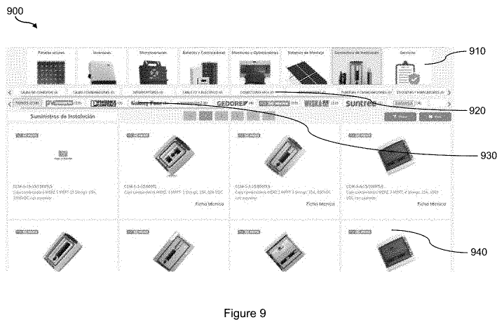

FIG. 9 is an example screenshot 900 of the online hierarchical search for a solar panel, where the one or more users 110 of the electronic device 150 select one class from the presentation of classes (or types or categories) of items/services displayed as images or text in row 910 (although illustrated as a row 910 in FIG. 9, the presentation may take the form of a column as well). Further, the one or more users 110 select the sub-class (sub-type or sub-category) of product/service from the choices displayed as series of images or text 920. The one or more users 110 select a brand (i.e., of a solar panel) from a series of brands 930 available based on the user selections and accordingly view a dynamically changing presentation of product choices 940 that are displayed as a function of the user's selection choices.

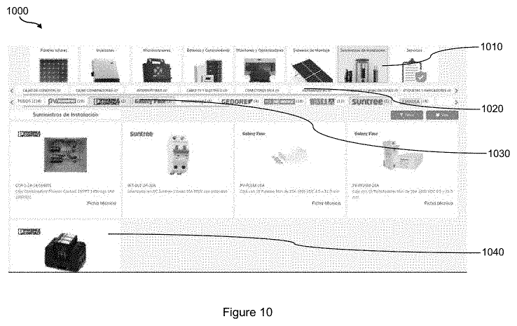

FIG. 10 is an example screenshot 1000 of the online hierarchical search for installation supplies, where the one or more users 110 of the electronic device 150 select one class from the presentation of classes (or types or categories) of items/services displayed as images or text in row 1010 (although illustrated as a row 1010 in FIG. 10, the presentation may take the form of a column as well). Further, the one or more users 110 select the sub-class (sub-type or sub-category) of product/service from the choices displayed as series of images or text 1020. The one or more users 110 select a brand (i.e., of installation supplies) from a series of brands 1030 available based on the user selections and accordingly view a dynamically changing presentation of product choices 1040 that are displayed as a function of the user's selection choices.

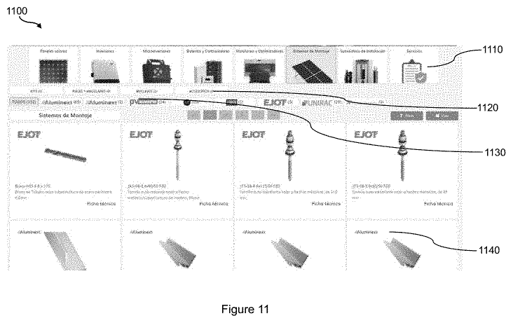

FIG. 11 is an example screenshot 1100 of the online hierarchical search for mounting systems, where the one or more users 110 of the electronic device 150 select one class from the presentation of classes (or types or categories) of items/services displayed as images or text in row 1110 (although illustrated as a row 1110 in FIG. 11, the presentation may take the form of a column as well). Further, the one or more users 110 select the sub-class (sub-type or sub-category) of product/service from the choices displayed as series of images or text 1120. The one or more users 110 select a brand (i.e., of mounting systems) from a series of brands 1130 available based on the user selections and accordingly view a dynamically changing presentation of product choices 1140 that are displayed as a function of the user's selection choices.

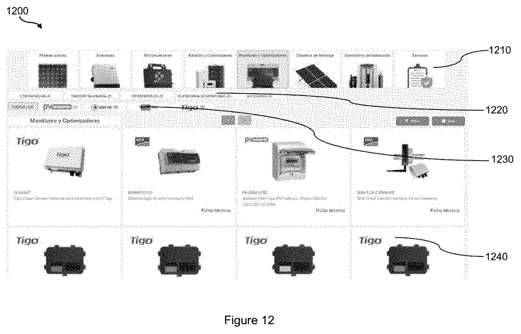

FIG. 12 is an example screenshot 1200 of the online hierarchical search for monitoring and optimizers, where the one or more users 110 of the electronic device 150 select one class from the presentation of classes (or types or categories) of items/services displayed as images or text in row 1210 (although illustrated as a row 1210 in FIG. 12, the presentation may take the form of a column as well). Further, the one or more users 110 select the sub-class (sub-type or sub-category) of product/service from the choices displayed as series of images or text 1220. The one or more users 110 select a brand (i.e., of monitoring and optimizers) from a series of brands 1230 available based on the user selections and accordingly view a dynamically changing presentation of product choices 1240 that are displayed as a function of the user's selection choices.

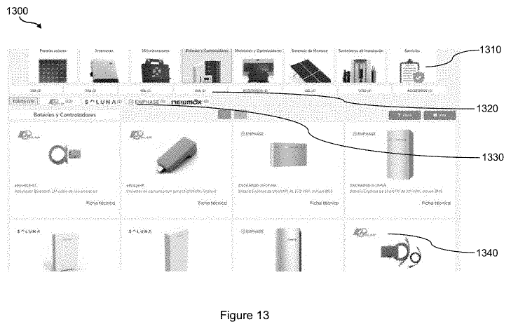

FIG. 13 is an example screenshot 1300 of the online hierarchical search for first brand type batteries and controllers, where the one or more users 110 of the electronic device 150 select one class from the presentation of classes (or types or categories) of items/services displayed as images or text in row 1310 (although illustrated as a row 1310 in FIG. 13, the presentation may take the form of a column as well). Further, the one or more users 110 select the sub-class (sub-type or sub-category) of product/service from the choices displayed as series of images or text 1320. The one or more users 110 select a brand (i.e., first brand type batteries and controllers) from a series of brands 1330 available based on the user selections and accordingly view a dynamically changing presentation of product choices 1340 that are displayed as a function of the user's selection choices.

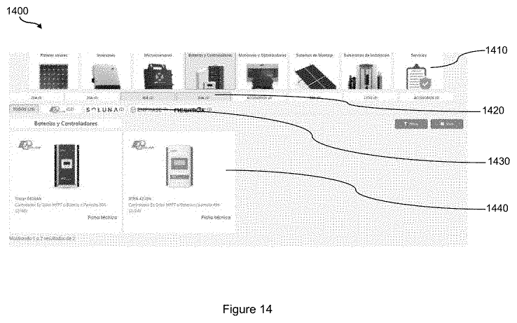

FIG. 14 is an example screenshot 1400 of the online hierarchical search for second brand type batteries and controllers, where the one or more users 110 of the electronic device 150 select one class from the presentation of classes (or types or categories) of items/services displayed as images or text in row 1410 (although illustrated as a row 1410 in FIG. 14, the presentation may take the form of a column as well). Further, the one or more users 110 select the sub-class (sub-type or sub-category) of product/service from the choices displayed as series of images or text 1420. The one or more users 110 select a brand (i.e., second brand type batteries and controllers) from a series of brands 1430 available based on the user selections and accordingly view a dynamically changing presentation of product choices 1440 that are displayed as a function of the user's selection choices.

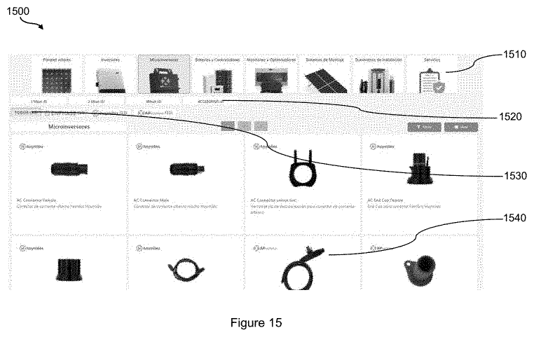

FIG. 15 is an example screenshot 1500 of the online hierarchical search for a microinverter, where the one or more users 110 of the electronic device 150 select one class from the presentation of classes (or types or categories) of items/services displayed as images or text in row 1510 (although illustrated as a row 1510 in FIG. 15, the presentation may take the form of a column as well). Further, the one or more users 110 select the sub-class (sub-type or sub-category) of product/service from the choices displayed as series of images or text 1520. The one or more users 110 select a brand (i.e., of microinverter) from a series of brands 1530 available based on the user selections and accordingly view a dynamically changing presentation of product choices 1540 that are displayed as a function of the user's selection choices.

In short, the display in rows, columns, or in the item display area may display product choices (including brands) shown in an order that “nudges” the customer to pick a particular one, and may be customized by the consumer/customer. In an embodiment, sponsored or featured suggestions such as “best deal” or “most users picked” may be displayed in order to influence purchase behaviour across an array of product and/or category criteria.

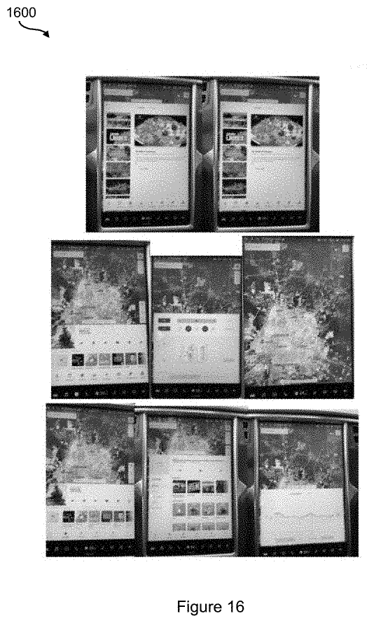

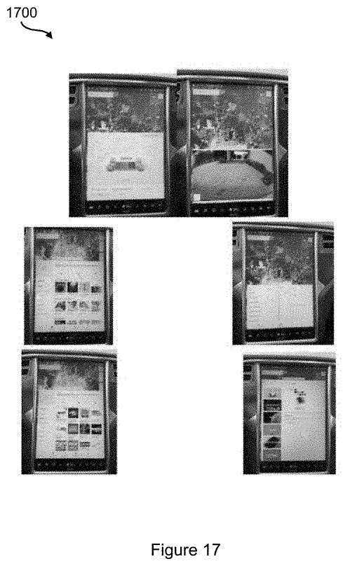

Now simultaneous reference is made to FIG. 16 and FIG. 17, in which FIG. 16 is an example screenshot 1600 of an in-vehicle display depicting the online hierarchical search for a song selection service and FIG. 17 is an example screenshot 1700 of an in-vehicle display depicting the online hierarchical search for a frequency modulation (FM) selection service.

Referring to FIG. 16 and FIG. 17, the accompanying images showing a Tesla display screen are instructive to perform the interactive online shopping. With the Tesla Touch Screen®, the user can see the different screens that are utilized, but not in a Hierarchical manner. The user selects an icon and is followed by a secondary screen instead of having categories in a top portion of the screen and with subsequent subcategories offered for selection (and yet other subcategories or options displayed in a corresponding hierarchical order).

Advantageously, the present invention provides a more efficient way of displaying search results, and makes it more convenient and efficient to purchase related goods on-line. Additionally, the system 100 and method for storing and comparing shopping cart contents allow a user to compare system-level of purchases such as an entire solar system installation or a branded stereo system by comparing bundled systems based on characteristics such as price, performance, or brand.

Of course, the hierarchical display and selection of products/services or services can belong to any criteria of industry, such as Retail/Grocery/Department stores, Online stores, electrical stores, electric cars, consumer goods (Smart Television, Appliances), solar products, heavy appliances, FMCG, consumer products (clothing, small appliances, books, food, etc.). Further, to the above embodiments, the present invention provides a user the ability to choose more than one criteria of products (by select more than one image or text in a row/column) taking the practical form of a logical OR function.

FIGS. 2 through 17 are to be understood in conjunction with FIG. 1. FIGS. 6 through 17 are example screen shots shown only for illustrative purposes and do not limit the scope of the present invention.

The various actions, acts, blocks, or the like in the flow diagrams may be performed in the order presented, in a different order or simultaneously. Further, in some embodiments, some of the actions, acts, blocks, or the like may be omitted, added, modified, skipped, or the like without departing from the scope of the present invention.

Unless otherwise defined, all technical and scientific terms used herein have the same meaning as commonly understood by one of ordinary skill in the art to which this invention belongs. Although methods and materials similar to or equivalent to those described herein can be used in the practice or testing of equivalent systems and methods, suitable systems and methods and are described above.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

What is claimed is:

1. A method for handling interactive online shopping, the method comprising:
receiving, by an electronic device, at least one input to determine and display at least one first data item from a plurality of first data items on a display of the electronic device in a direction;
selecting, by the electronic device, the at least one first data item from the plurality of first data items to navigate to at least one second data item from a plurality of second data items on the display of the electronic device based on the selection, wherein the at least one second data item corresponds to at least one sub-category of the at least one first data item;
selecting, by the electronic device, the at least one second data item from the plurality of second data items to navigate to at least one third data item from a plurality of third data items on the display of the electronic device based on the selection, wherein the at least one third data item corresponds to at least one sub-category of the at least one second data item; and
performing, by the electronic device, at least one action on the at least one selected data item.

2. The method of claim 1 wherein performing, by the electronic device, at least one action on the at least one selected data item comprises:
initiating, by the electronic device, a purchase transaction for the at least one selected data item; and
receiving, by the electronic device, a payment confirmation for the at least one selected data item.

3. The method of claim 1 wherein performing, by the electronic device, at least one action on the at least one selected data item comprises:
allowing, by the electronic device, a user of the electronic device to add the at least one selected data item in a cart.

4. The method of claim 3 further comprises:
initiating, by the electronic device, a purchase transaction for the at least one selected data item in the cart; and
receiving, by the electronic device, a payment confirmation for the at least one selected data item in the cart.

5. The method of claim 1 wherein performing, by the electronic device, at least one action on the at least one selected data item comprises:
comparing, by the electronic device, two or more selected data items; and
identifying and purchasing, by the electronic device, an optimal data item from the two or more selected data items based on the comparison.

6. The method of claim 1 wherein the at least one data item comprises a product and a service, wherein the direction comprises at least one of a horizontal direction, a vertical direction, a diagonal direction, a top-to-bottom direction, and a bottom to top direction.

7. The method of claim 1 wherein the at least one first data item, the at least one second data item and the at least one third data item are arranged in a sequential order.

8. The method of claim 1 wherein the at least one sub-category is determined based on a context of the at least one input and a common feature of the at least one selected data item.

9. An electronic device, comprising:
a processor;
a memory; and
an online shopping handling block, coupled with the processor and the memory, configured to:
receive at least one input to determine and display at least one first data item from a plurality of first data items on a display of the electronic device in a direction;
select the at least one first data item from the plurality of first data items to navigate to at least one second data item from a plurality of second data items on the display of the electronic device based on the selection, wherein the at least one second data item corresponds to at least one sub-category of the at least one first data item;
select the at least one second data item from the plurality of second data items to navigate to at least one third data item from a plurality of third data items on the display of the electronic device based on the selection, wherein the at least one third data item corresponds to at least one sub-category of the at least one second data item; and
perform at least one action on the at least one selected data item.

10. The electronic device of claim 9 wherein perform at least one action on the at least one selected data item comprises:
initiate a purchase transaction for the at least one selected data item; and
receive a payment confirmation for the at least one selected data item.

11. The electronic device of claim 9 wherein perform at least one action on the at least one selected data item comprises:
allow a user of the electronic device to add the at least one selected data item in a cart.

12. The electronic device of claim 11, further comprises:
initiate a purchase transaction for the at least one selected data item in the cart; and
receive, by the electronic device, a payment confirmation for the at least one selected data item in the cart.

13. The electronic device of claim 9 wherein perform at least one action the at least one selected data item comprises:
compare the two or more selected data items; and
identify and purchase an optimal data item from the two or more selected data items based on the comparison.

14. The electronic device of claim 9 wherein the at least one data item comprises a product and a service, wherein the direction comprises at least one of a horizontal direction, a vertical direction, a diagonal direction, a top-to-bottom direction, and a bottom to top direction.

15. The electronic device of claim 9 wherein the at least one first data item, the at least one second data item and the at least one third data item are arranged in a sequential order.

16. The electronic device of claim 9 wherein the at least one sub-category is determined based on a context of the at least one input and a common feature of the at least one selected data item.
